(19) United States
(12) Patent Application Publication
(10) Pub. No.: US 2026/0050815 A1
(43) Pub. Date: Feb. 19, 2026

(54) Validation and Optimization of Quantum Error Mitigation Workflows

(71) Applicant: International Business Machines Corporation, Armonk, NY (US)

(72) Inventors: Derek WANG, New York, NY (US); Haimeng ZHANG, New York, NY (US); Swarnadeep MAJUMDER, Durham, NC (US); Pedro RIVERO RAMIREZ, Long Island City, NY (US); Andrew EDDINS, Washington, DC (US); Drew VANDETH, Essex Junction, VT (US); Minh TRAN, Cambridge, MA (US); Kunal SHARMA, White Plains, NY (US); Zlatko Kristev MINEV, White Plains, NY (US); Nathan Don EARNEST-NOBLE, New York, NY (US)

(21) Appl. No.: 18/802,653

(22) Filed: Aug. 13, 2024

(51) Int. Cl. G06N 10/70; G06N 10/20

(52) U.S. Cl. CPC G06N 10/70; G06N 10/20

(57) ABSTRACT

Systems and techniques that facilitate scalable validation and optimization of quantum error mitigation computational workflows are provided. For example, one or more embodiments described herein can comprise a system, which can comprise a memory that can store computer executable components. The system can also comprise a processor, operably coupled to the memory that can execute the computer executable components stored in memory. The computer executable components can comprise an input component that receives a quantum error mitigation (QEM) configuration of a quantum circuit and a quantum execution backend; a quantum circuit conversion component that converts the quantum circuit into a classically simulable quantum circuit; a noise component that learns a simplified noise model of the quantum execution backend; and an evaluation component that validates or optimizes the QEM configuration over the classically simulable quantum circuit and the simplified noise model.

### BACKGROUND

The subject disclosure relates to quantum error mitigation, and more specifically, to scalable validation and optimization of quantum error mitigation computational workflows.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, and/or computer program products that facilitate scalable validation and optimization of quantum error mitigation computational workflows are provided.

According to an embodiment, a system can comprise a memory that stores computer executable components. The system can further comprise a processor that executes the computer executable components stored in the memory. In various embodiments, the computer executable components can comprise an input component that receives a quantum error mitigation (QEM) configuration of a quantum circuit and a quantum execution backend. In various aspects, the computer executable components can further comprise a quantum circuit conversion component that converts the quantum circuit into a classically simulable quantum circuit. In various embodiments, the computer executable components can further comprise a noise component that learns a simplified noise model of the quantum execution backend. In various aspects, the computer executable components can further comprise an evaluation component that validates or optimizes the QEM configuration over the classically simulable quantum circuit and the simplified noise model.

According to another embodiment, a computer-implemented method can comprise, receiving, by a system operatively coupled to a processor, a quantum error mitigation (QEM) configuration of a quantum circuit and a quantum execution backend. In various embodiments, the computer-implemented method can further comprise converting, by the system, the quantum circuit into a classically simulable quantum circuit. In various aspects, the computer-implemented method can further comprise learning, by the system, a simplified noise model of the quantum execution backend. In various embodiments, the computer-implemented method can further comprise validating or optimizing, by the system, the QEM configuration over the classically simulable quantum circuit and the simplified noise model.

According to another embodiment, a computer program product for scalable validation and optimization of quantum error mitigation computational workflows comprising a computer readable storage medium having program instructions embodied therewith, the program instructions executable by a processor to cause the processor to receive a quantum error mitigation (QEM) configuration of a quantum circuit and a quantum execution backend. In various embodiments, the program instructions can be further executable by the processor to cause the processor to convert the quantum circuit into a classically simulable quantum circuit. In various aspects, the program instructions can be further executable by the processor to cause the processor to learn a simplified noise model of the quantum execution backend. In various embodiments, the program instructions can be further executable by the processor to cause the processor to validate or optimize the QEM configuration over the classically simulable quantum circuit and the simplified noise model.

### DESCRIPTION OF THE DRAWINGS

FIG. 1 illustrates a block diagram of example, non-limiting systems that can facilitate scalable validation and optimization of quantum error mitigation computational workflows in accordance with one or more embodiments described herein.

FIG. 2 illustrates a block diagram of example, non-limiting systems including a classically simulable quantum circuit, a simplified noise model, and a cost function that can facilitate scalable validation and optimization of quantum error mitigation computational workflows in accordance with one or more embodiments described herein.

FIG. 3 illustrates an example, non-limiting diagram of a cost function in accordance with one or more embodiments described herein.

FIG. 4 illustrates a block diagram of example, non-limiting systems including a set of constraints and a set of starting points that can facilitate scalable validation and optimization of quantum error mitigation computational workflows in accordance with one or more embodiments described herein.

FIG. 5 illustrates an example, non-limiting diagram of a set of constraints and a set of starting points in accordance with one or more embodiments described herein.

FIG. 6 illustrates an example, non-limiting diagram of a workflow of scalable validation and optimization of quantum error mitigation computational workflows in accordance with one or more embodiments described herein.

FIG. 7 illustrates an example, non-limiting diagram of a workflow of scalable validation and optimization of quantum error mitigation computational workflows in accordance with one or more embodiments described herein.

FIG. 8 illustrates a block diagram of an example, non-limiting system that can facilitate scalable validation and optimization of quantum error mitigation computational workflows in accordance with one or more embodiments described herein.

FIG. 9 illustrates an example, non-limiting diagram of converting a quantum circuit into a classically simulable quantum circuit in accordance with one or more embodiments described herein.

FIG. 10 illustrates an example, non-limiting diagram of converting a quantum circuit into a classically simulable quantum circuit in accordance with one or more embodiments described herein.

FIG. 11 illustrates an example, non-limiting diagram of selecting a simplified noise model in accordance with one or more embodiments described herein.

FIG. 12 illustrates an example, non-limiting diagram of optimization inputs and an optimization search space in accordance with one or more embodiments described herein.

FIG. 13 illustrates an example, non-limiting diagram of memory overhead and efficiency of evaluating cost functions in accordance with one or more embodiments described herein.

FIG. 14 illustrates an example, non-limiting diagram of simulation results of a quantum circuit in accordance with one or more embodiments described herein.

FIG. 15 illustrates a flow diagram of an example, non-limiting method that can facilitate predictive profiling of quantum environments in accordance with one or more embodiments described herein.

FIG. 16 illustrates a flow diagram of an example, non-limiting method that can facilitate predictive profiling of quantum environments in accordance with one or more embodiments described herein.

FIG. 17 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

According to an embodiment, a system can comprise a memory that stores computer executable components. The system can further comprise a processor that executes the computer executable components stored in the memory. In various embodiments, the computer executable components can comprise an input component that receives a quantum error mitigation (QEM) configuration of a quantum circuit and a quantum execution backend. In various aspects, the computer executable components can further comprise a quantum circuit conversion component that converts the quantum circuit into a classically simulable quantum circuit. In various embodiments, the computer executable components can further comprise a noise component that learns a simplified noise model of the quantum execution backend. In various aspects, the computer executable components can further comprise an evaluation component that validates or optimizes the QEM configuration over the classically simulable quantum circuit and the simplified noise model. Such embodiments of the system can provide a number of advantages, including improved scalability of validating and optimizing QEM workflows, reduced overhead of quantum resources for QEM workflows, improved processing efficiency of validating and optimizing QEM workflows, and enhanced applicability of QEM validation and optimization across different QEM methods.

In one or more embodiments of the aforementioned system, the input component can receive a cost function, wherein the cost function comprises a set of fixed variables and a set of optimizable variables. Such embodiments of the system can provide a number of advantages, including

In one or more embodiments of the aforementioned system, validating the QEM configuration can comprise estimating the cost function at the QEM configuration. Such embodiments of the system can provide a number of advantages, including reduced memory overhead and improved processing efficiency of cost function evaluation.

In one or more embodiments of the aforementioned system, optimizing the QEM configuration can comprise minimizing the cost function to obtain an optimized QEM configuration over the fixed variables and the optimizable variables. Such embodiments of the system can provide a number of advantages, including improved scalability of validating and optimizing QEM workflows, reduced overhead of quantum resources for QEM workflows, and improved processing efficiency of validating and optimizing QEM workflows.

In one or more embodiments of the aforementioned system, validating or optimizing the QEM configuration can comprise simulating the classically simulable quantum circuit using the simplified noise model over the QEM configuration. Such embodiments of the system can provide a number of advantages, including reduced overhead of quantum resources for QEM workflows and improved processing efficiency of validating and optimizing QEM workflows.

In one or more embodiments of the aforementioned system, the input component can receive starting points for simulation of the classically simulable quantum circuit. In one or more embodiments of the aforementioned system, the starting points can comprise at least one of: initial conditions, configurations, or parameters for the simulation. Such embodiments of the system can provide a number of advantages, including enhanced applicability of QEM validation and optimization across different QEM methods.

In one or more embodiments of the aforementioned system, the input component can receive constraints on a search space for simulation of the classically simulable quantum circuit. In one or more embodiments of the aforementioned system, the constraints on the search space can comprise constraints on at least one of: types of gates, number of qubits simulated, number of gates simulated, or boundaries of simulation parameters for the simulation. Such embodiments of the system can provide a number of advantages, including enhanced applicability of QEM validation and optimization across different QEM methods.

In one or more embodiments of the aforementioned system, the set of fixed variables and a set of optimizable variables in the cost function can quantify a total number of executions, a level of precision of QEM results, noise factors, or runtime. Such embodiments of the system can provide a number of advantages, including enhanced applicability of QEM validation and optimization across different QEM methods.

In one or more embodiments of the aforementioned system, the evaluation component can evaluate the cost function using stabilizer simulation backends. Such embodiments of the system can provide a number of advantages, including improved processing efficiency of validating and optimizing QEM workflows.

In one or more embodiments of the aforementioned system, converting the quantum circuit into a classically simulable quantum circuit can comprise converting the quantum circuit into a classically simulable proxy circuit. Such embodiments of the system can provide a number of advantages, including improved processing efficiency of validating and optimizing QEM workflows and reduced overhead of quantum resources for QEM workflows.

According to various embodiments, the above-described system can be implemented as a computer-implemented method or as a computer program product.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Quantum computation leverages principles such as superposition and entanglement to perform calculations that are computationally infeasible for classical systems. However, quantum hardware is inherently prone to noise, which can introduce errors in quantum computations. To counteract these errors, quantum error mitigation (QEM) methods can be employed to enhance the accuracy of estimated expectation values of observables. QEM can include methods that reduce the noise-induced bias and variance of quantum computations by using additional resources (e.g., executing additional shots or circuits). There are variety of QEM methods that can be employed, such as probabilistic error cancellation (PEC), probabilistic error amplification (PEA), zero-noise extrapolation (ZNE), or Clifford data regression (CDR).

However, each QEM method comprises its own settings and parameters that can be optimized over. Therefore, optimizing QEM can be complex, as it is dependent on the QEM method employed. In other words, to determine a suitable or optimized configuration of the QEM method, each QEM method requires a tailored approach to optimization that considers its specific parameters and settings to achieve the best performance. Existing techniques lack broad applicability across different QEM methods to account for this. That is, existing methods are designed with specific error mitigation strategies based on the QEM method employed, each with distinct characteristics or requirements. As a result, existing methods of validating or optimizing the QEM workflow may not generalize well to different QEM techniques that have unique parameters for optimization. Such a lack of flexibility limits the effectiveness of existing methods when applied to various QEM approaches, thereby necessitating the development of more adaptable and universal validation and optimization strategies that can accommodate the varied and evolving landscape of quantum error mitigation methods. In other words, a method for validating and optimizing the QEM computational workflow that is more comprehensive and applicable to any QEM method can be desirable.

Moreover, despite advancements in QEM for quantum computing, much of existing techniques include running experiments for QEM on quantum hardware. For instance, some existing method involves running extensive calibration experiments on quantum hardware with a brute force approach, which is unscalable and infeasible due to the computational overhead. Existing methods are constrained by a reliance on actual hardware for calibration of QEM methods, which introduces additional limitations. Specifically, estimation of a cost function through physical experiments can be time-consuming and resource-intensive, further reducing the practicality of such approaches. Their dependence on hardware can limit the scope of problems that can be addressed and hinder the development of more efficient and accessible QEM techniques. Consequently, it can be desirable for a more scalable and classically efficient method that can optimize QEM settings without exhaustive hardware usage, thereby enhancing the feasibility and effectiveness of quantum computations.

In view of the problems discussed above, in relation to validating and optimizing the QEM computation workflows, the present disclosure can be implemented to produce a solution to one or more of these problems by receiving QEM configuration of a quantum circuit and a quantum execution backend, converting the quantum circuit into a classically simulable quantum circuit, and learning a simplified noise model of the quantum execution backend. By converting the quantum circuit into a classically simulable quantum circuit, and learning a simplified noise model of the quantum execution backend, validation or optimization of the QEM configuration over the classically simulable quantum circuit and the simplified noise model can be performed efficiently with no quantum computational overhead, allowing for scalable and accurate QEM results in any QEM method.

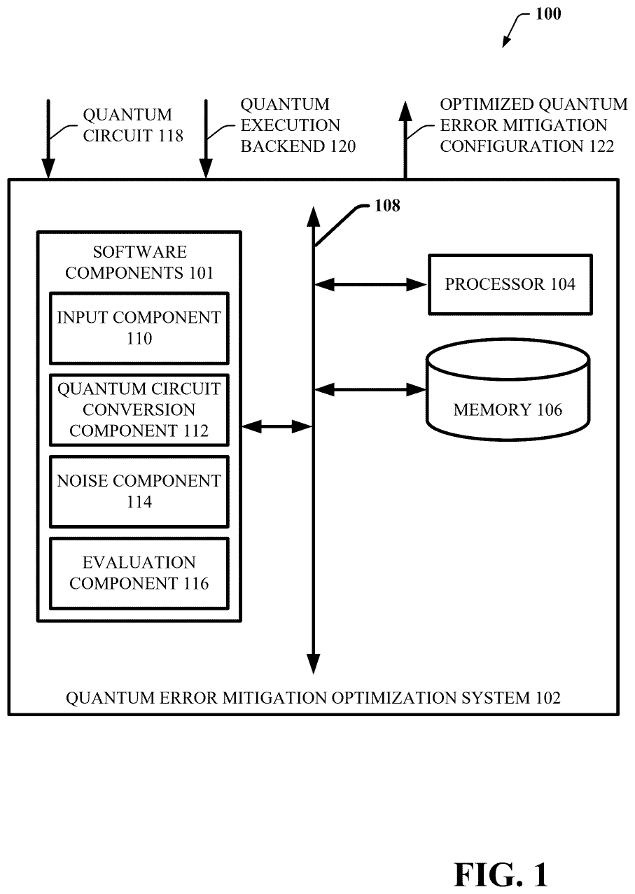

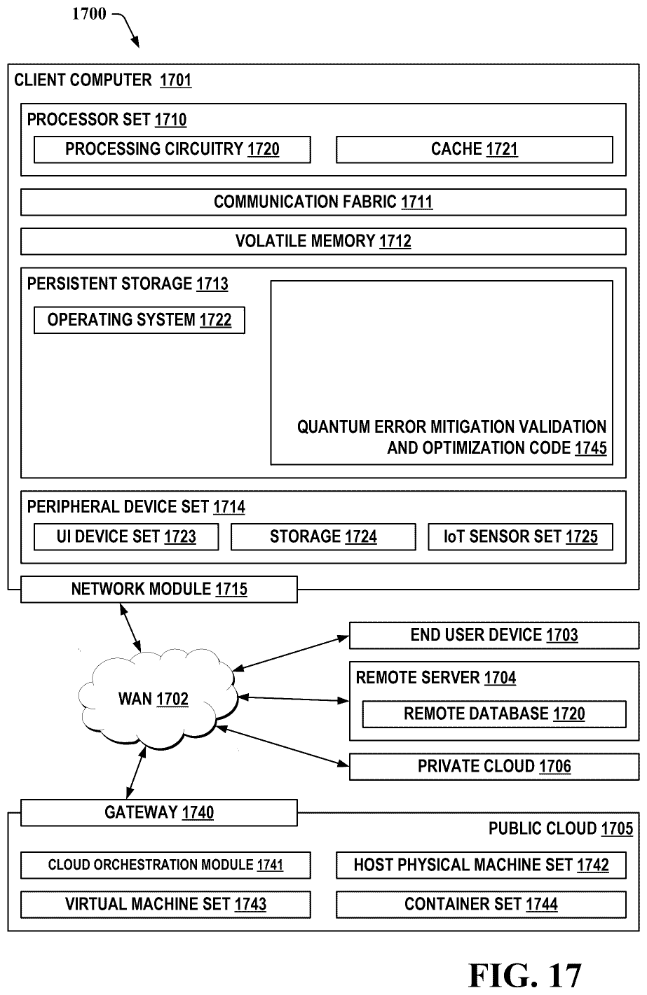

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 (e.g., system 100) as illustrated at FIG. 1, and/or systems thereof, can further comprise, be associated with and/or be coupled to one or more computer and/or computing-based elements described herein with reference to an operating environment, such as the operating environment 1700 illustrated at FIG. 17. For example, system 100 can be associated with, such as accessible via, a computing environment 1700 described below with reference to FIG. 17, such that aspects of processing can be distributed between system 100 and the computing environment 1700. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates block diagram of an example, non-limiting system 100 that can facilitate scalable validation and optimization of QEM computational workflows in accordance with one or more embodiments described herein. Aspects of systems (e.g., quantum error mitigation optimization system 102 and the like), apparatuses or processes in various embodiments of the present invention, can constitute one or more machine-executable components embodied within one or more machines (e.g., embodied in one or more computer readable mediums (or media) associated with one or more machines). Such components, when executed by the one or more machines (e.g., computers, computing devices, virtual machines, etc.), can cause the machines to perform the operations described. Quantum error mitigation optimization system 102 can comprise processor 104, memory 106, and software components 101, the software components 101 comprising input component 110, quantum circuit conversion component 112, noise component 114, and/or evaluation component 116.

System 100 and/or the components of system 100 can be employed to use hardware and/or software to solve problems that are highly technical in nature (e.g., related to quantum computing, intelligent profiling predictions of quantum environments, optimized resource allocation, etc.), that are not abstract and that cannot be performed as a set of mental acts by a human. Further, some of the processes performed may be performed by specialized computers for carrying out defined tasks related to optimizing resource allocation in quantum environments. The system 100 and/or components of the system can be employed to solve new problems that arise through advancements in technologies mentioned above, quantum computing, and/or the like. The system 100 can provide technical improvements in terms of optimizing resource allocations between classical and quantum components in quantum environments and improving efficiency of execution by optimizing resource allocations prior to execution, etc.

Discussion turns briefly to processor 104, memory 106 and bus 108 of system 100. For example, in one or more embodiments, the system 100 can comprise processor 104 (e.g., computer processing unit, microprocessor, classical processor, and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, system 100 can comprise a computer-readable memory (e.g., memory 106) that can be operably connected to the processor 104. Memory 106 can store computer-executable instructions that, upon execution by processor 104, can cause processor 104 and/or one or more other components of system 100 (e.g., software components 101, input component 110, quantum circuit conversion component 112, noise component 114, evaluation component 116) to perform one or more actions. In one or more embodiments, memory 106 can store computer-executable components (e.g., software components 101, input component 110, quantum circuit conversion component 112, noise component 114, evaluation component 116).

System 100 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

As described above, in addition to the processor 104 and/or memory 106 described above, system 100 can comprise one or more computer and/or machine readable, writable and/or executable components and/or instructions that, when executed by processor 104, can enable performance of one or more operations defined by such component(s) and/or instruction(s).

In various embodiments, input component 110 can receive a quantum circuit 118. That is, in various aspects, input component 110 can receive a quantum circuit representation of quantum circuit 118. The quantum circuit representation can comprise the quantum circuit 118 represented in any suitable manner (e.g., gate-based representations, state vector representations, density matrix representation, tensor network representations). For example, the input quantum circuit representation can be a standard circuit representation such as QASM, QPY, or other similar formats.

In various embodiments, quantum circuit conversion component 112 can convert the quantum circuit 118 into a classically simulable quantum circuit (CQC). A CQC is a quantum circuit that can be efficiently simulated on a classical computer. This means that the computational resources required to simulate the quantum circuit are manageable for classical algorithms and hardware. In various instances, quantum circuit conversion component 112 can convert the quantum circuit 118 into a classically simulable proxy circuit. A classically simulable proxy circuit is a simplified or approximate version of a quantum circuit that is designed to be classically simulable. The classically simulable proxy circuit can be used to estimate or model the behavior of a more complex quantum circuit, such as the quantum circuit 118. In any case, quantum circuit conversion component 112 can convert the quantum circuit 118 into a quantum circuit that can be classically simulated on classical hardware.

In various aspects, input component 110 can receive a QEM configuration of quantum circuit 118. The QEM configuration of the quantum circuit 118 can refer to a particular setup or parameters to be used for applying a QEM method to the quantum circuit 118. In other words, the QEM configuration can be defined by a selected QEM method to be applied to the quantum circuit 118. In various aspects, any suitable QEM method and corresponding QEM configuration can be selected and received by input component 110. For example, input component 110 can receive a QEM configuration corresponding to zero-noise extrapolation, wherein the QEM configuration identifies the parameters of ZNE (e.g., noise scaling factors, number of shots). In any case, by converting the quantum circuit 118 into a CQC, quantum computational overhead can be reduced when optimizing or validating the QEM configuration.

In various embodiments, input component 110 can receive a quantum execution backend 120. The quantum execution backend 120 can represent the quantum hardware that will run the quantum circuit 118 with the QEM configuration applied. For instance, the quantum execution backend 120 can represent the quantum processor or simulator on which quantum circuit 118 will be executed. In various aspects, the quantum execution backend 120 can be the parameters or characteristics that describe the quantum execution backend 120 (e.g., quantum hardware specifications, calibration data, measurement results, access APIs or interfaces).

In various embodiments, noise component 114 can, as described herein, learn a simplified noise model of the quantum execution backend. A simplified noise model is a noise model that can be constructed with low overhead from measurements on quantum hardware. Further, a simplified noise model can be efficiently classically simulated. For example, the simplified noise model can be, but is not limited to, a Pauli noise model, depolarizing noise model, or sparse Lindblad model.

In various embodiments, evaluation component 116 can, as described herein, validate or optimize the QEM configuration over the classically simulable quantum circuit and the simplified noise model. Validating the QEM configuration can refer to evaluating the error at the QEM configuration. Further, validating the QEM computational workflow can comprise estimating result statistics for the QEM computational workflow or payload. Optimizing the QEM configuration can refer to obtaining an optimized QEM configuration 122 that achieves a desired quality (e.g., accuracy) of results for the QEM computational workflow or payload. In particular, optimizing the QEM computational workflow can include optimizing the QEM configuration to minimize the impact of noise while minimizing computational resources, and thereby improving accuracy of quantum computations.

In various aspects, once the optimized QEM configuration 122 has been determined by evaluation component 116, the quantum circuit 118 can be executed under the optimized QEM configuration 122 to achieve results with improved accuracy. Such embodiments can provide a number of advantages, including reducing the quantum computational overhead for improving QEM accuracy by obtaining the optimized QEM configuration 122 classically. Furthermore, such embodiments can be applied to any QEM method and corresponding QEM configuration, thereby providing a comprehensive method for validating or optimizing QEM computational workflows.

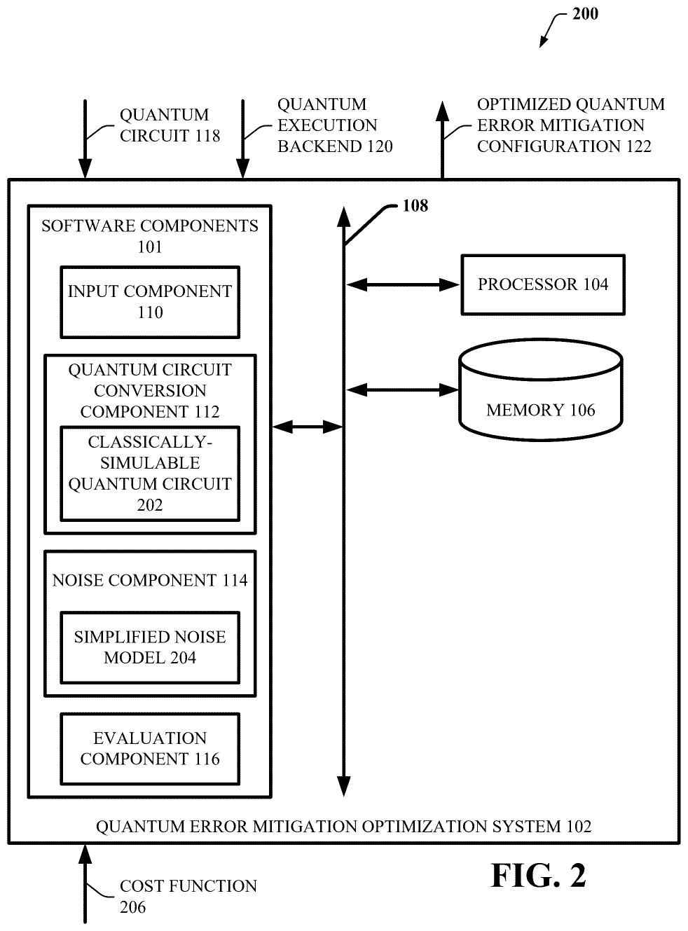

FIG. 2 illustrates a block diagram of an example, non-limiting system 300 including a classically simulable quantum circuit, a simplified noise model, and a cost function that can facilitate scalable validation and optimization of QEM computational workflows in accordance with one or more embodiments described herein. As shown, the system 200 can, in some cases, comprise the same components as the system 100, and can further comprise a classically simulable quantum circuit 202, a simplified noise model 204, and a cost function 206.

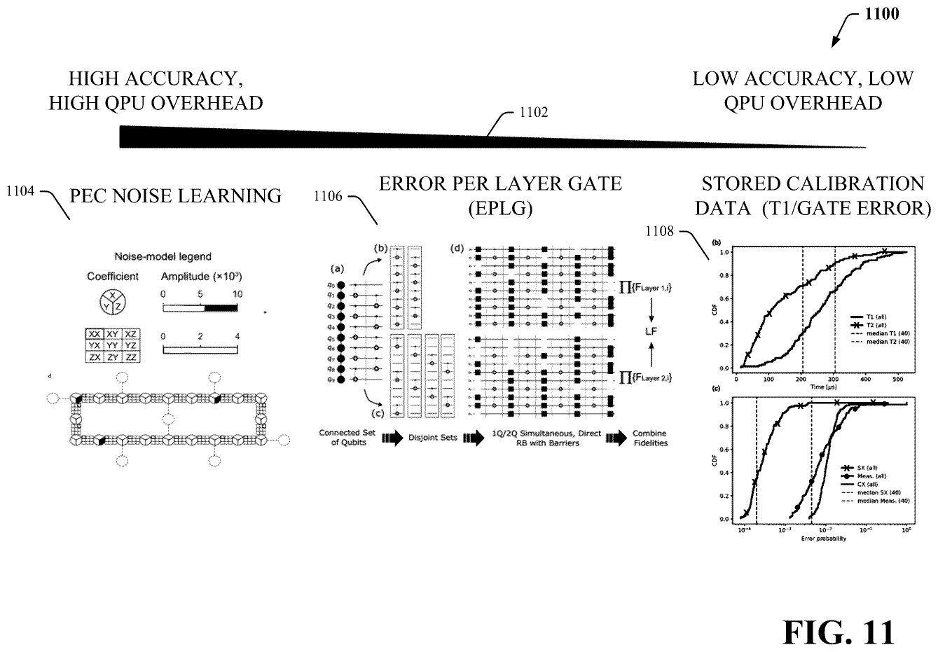

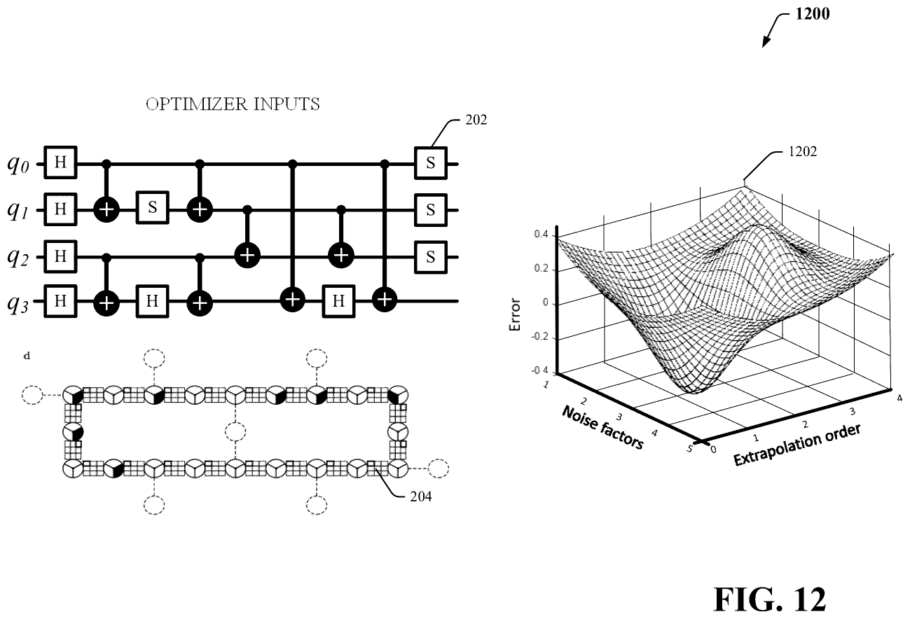

In various embodiments, the conversion component 112 can access the quantum circuit 118 to generate the classically simulable quantum circuit 202 (e.g., CQC 202). In other words, the conversion component 112 can convert the quantum circuit 118 into CQC 202. In some instances, the CQC 202 can be a classically simulable proxy circuit. In various aspects, the conversion component 112 can employ any suitable method to convert quantum circuit 118 into CQC 202. In some instances, conversion component 112 can employ circuit approximation. Circuit approximation can comprise approximating complex gates in quantum circuit 118 with simpler, local gates to enable classical simulation while retaining the behavior of quantum circuit 118. As a non-limiting example, conversion component 112 can employ Cliffordization on quantum circuit 118 to generate CQC 202. Cliffordization is a process that can transform a non-Clifford circuit into a Clifford circuit (e.g., a quantum circuit that only uses Clifford gates). Non-limiting examples are described with respect to FIGS. 11 and 12.

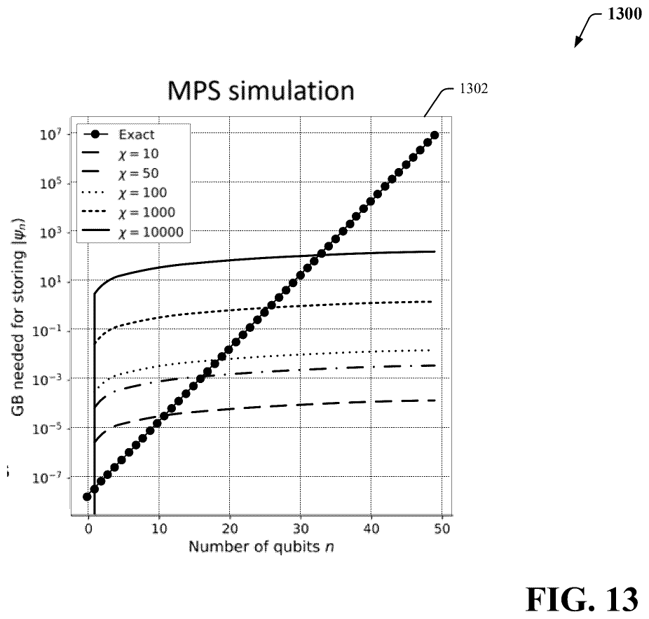

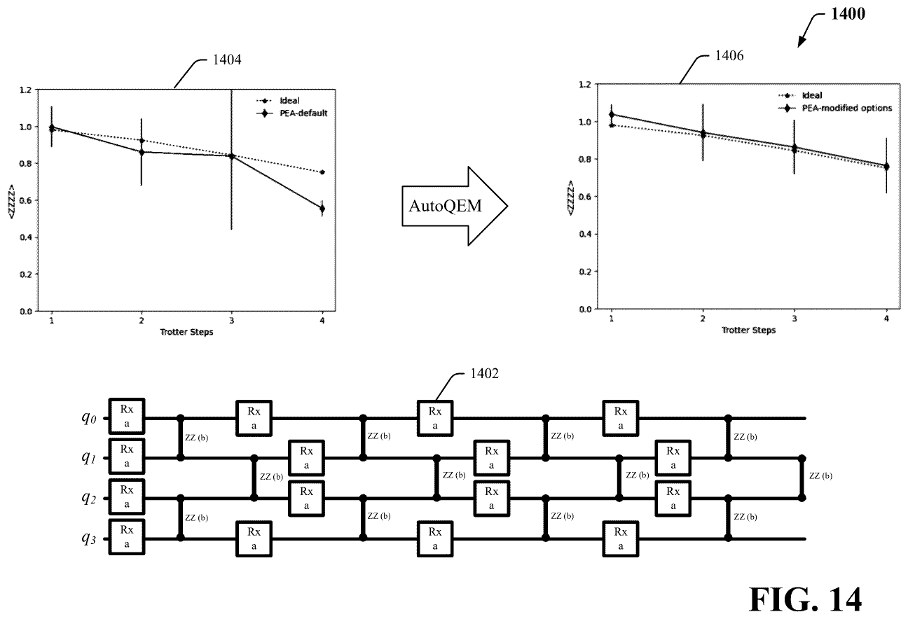

In various embodiments, the noise component 114 can learn the simplified noise model 204 of the quantum execution backend 120. That is, noise component 114 can approximate the noise in the quantum execution backend 120. For instance, the simplified noise model 204 can emulate the noise present on the quantum processor. In various aspects, the noise component 114 can employ any suitable method to learn noise model 204. As a non-limiting example, noise component 114 can learn a local Pauli noise model of the quantum execution backend 120. A local Pauli noise model is a noise model that assumes that noise acts locally on individual qubits and can be represented by Pauli errors. Various aspects and non-limiting are described with respect to FIGS. 13 and 14.

In various embodiments, the input component 110 can receive cost function 206. In various aspects, the evaluation component 116 can evaluate the cost function 206 to determine the optimized QEM configuration 122. In various instances, the evaluation component 116 can estimate the cost function 206 for the QEM configuration received to validate the QEM computational workflow. In various cases, the evaluation component 116 can optimize the QEM computational workflow by minimizing the cost function 206 to determine the optimized QEM configuration 122.

In some aspects, evaluation of the cost function 206 can be facilitated by using stabilizer simulation backends. Stabilizer simulation backends (e.g., Quipper, CHP simulator, ProjectQ, Qiskit) can provide efficient classical simulation of quantum circuits composed primarily of stabilizer states and operations.

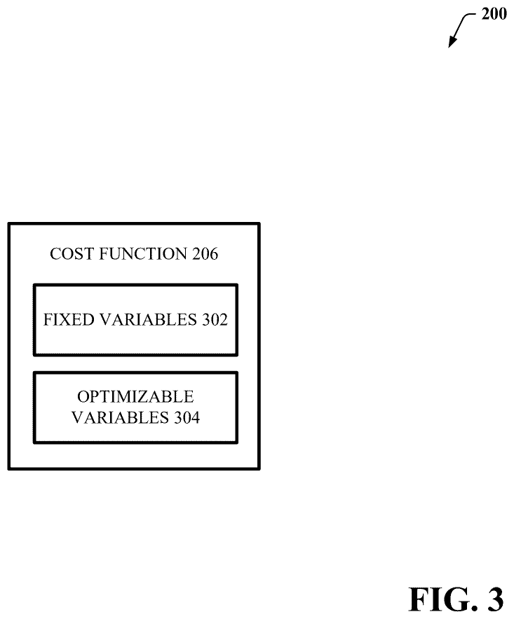

FIG. 3 illustrates a non-limiting example of a block diagram 300 of a cost function in accordance with one or more embodiments described herein.

In various embodiments, the cost function 206 can comprise a set of fixed variables 302 and a set of optimizable variables 304. The set of fixed variables 302 are parameters or conditions in cost function 206 that remain constant throughout the optimization process. The set of fixed variables 302 variables do not change and can be set before optimization begins. As a non-limiting example, the set of fixed variables 302 can include variables that define hardware constraints, such as limitations or capabilities of the quantum hardware the quantum circuit 118 is to be executed on. As another non-limiting example, the set of fixed variables 302 can include variables that define circuit structure of the quantum circuit 118, such as the sequence of gates or types of gates used. As yet another non-limiting example, the set of fixed variables 302 can include variables that define error rates, such as baseline error rates of the quantum hardware. As still another non-limiting example, the set of fixed variables 302 can include variables that define a desired level of accuracy of the QEM method to be applied to execution of quantum circuit 118.

The set of optimizable variables 304 are parameters within the cost function that can be adjusted during the optimization process to improve performance or reduce error. As a non-limiting example, the set of optimizable variables 304 can include variables that define error mitigation parameters, such as scaling factors or weights. As another non-limiting example, the set of optimizable variables 304 can include variables that define control parameters. Such as parameters that can adjust the performance of quantum gates or circuits (e.g., gate times, pulse amplitudes). As still another non-limiting example, the set of optimizable variables 304 can include variables that define the total number of shots for executing quantum circuit 118.

In any case, the set of fixed variables 302 and the set of optimizable variables 304 can be determined based on the QEM configuration received by input component 110. That is, based on the QEM configuration that corresponds to a QEM method that is desired to apply to quantum circuit 118, the set of fixed variables 302 and the set of optimizable variables 304 can be selected from the QEM configuration. For instance, an entity can identify or input which of the QEM configuration is to be included in the set of fixed variables 302 and which of the QEM configuration is to be included in the set of optimizable variables 304.

In various embodiments, based on the QEM configuration, the set of fixed variables 302 and the set of optimizable variables 304 can be automatically determined. For example, based on the QEM method desired, a default assignment of the set of fixed variables 302 and the set of optimizable variables 304 can be defined.

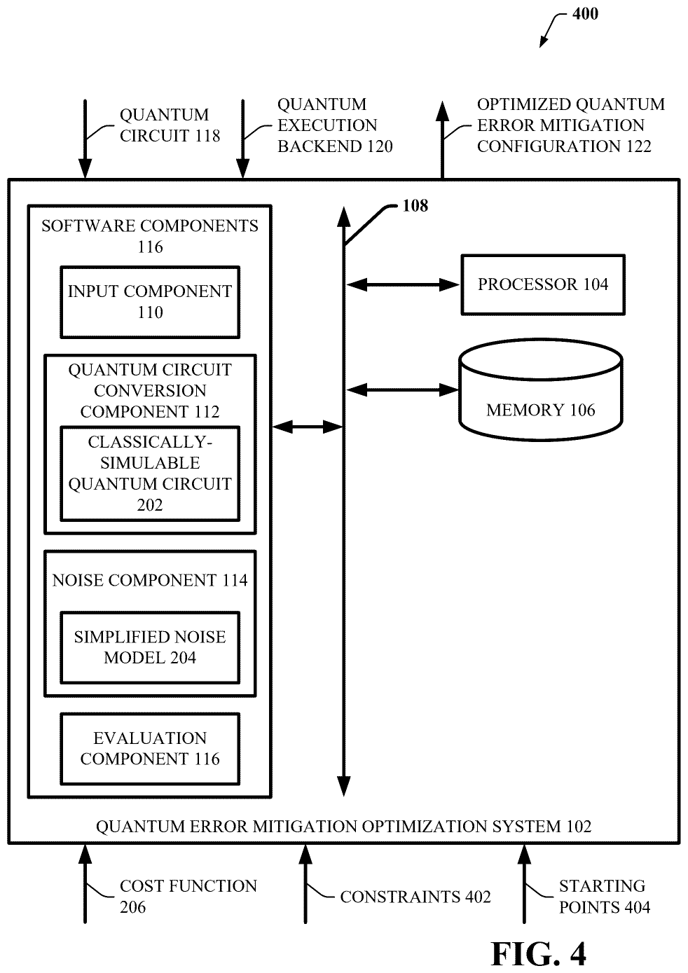

FIG. 4 illustrates a block diagram of an example, non-limiting system 400 including a set of constraints and a set of starting points that can facilitate scalable validation and optimization of QEM computational workflows in accordance with one or more embodiments described herein. As shown, the system 400 can, in some cases, comprise the same components as the system 200, and can further comprise a set of constraints 402 and a set of starting points 404.

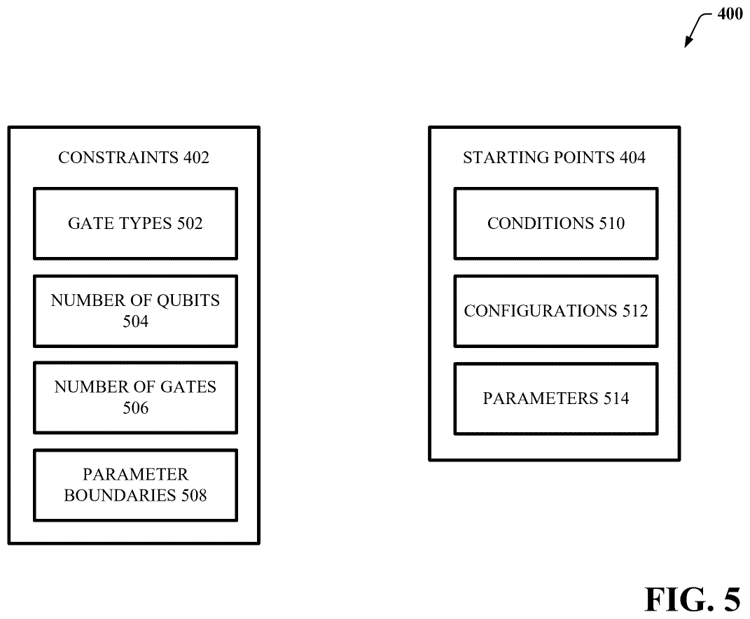

In various embodiments, the input component 110 can also receive defined preferences from an entity. In particular, the input component 110 can receive the set of constraints 402 or the set of starting points 404. In some cases, the set of constraints 402 or the set of starting points 404 can be utilized to determine the method to convert the quantum circuit 118 into CQC 202. That is, the method to convert the quantum circuit 118 into CQC 202 can be selected such that the CQC 202 adheres to the set of constraints 402 or the set of starting points 404. Various aspects of the set of constraints 402 or the set of starting points 404 are discussed with respect to FIG. 5.

FIG. 5 illustrates an example, non-limiting diagram 500 of a set of constraints and a set of starting points in accordance with one or more embodiments described herein.

In various aspects, the set of constraints 402 can comprise parameters that can restrict a search space for simulation of the CQC 202 with the simplified noise model 204. That is, the set of constraints 402 can limit or restrict the QEM configuration space. As a non-limiting example, the set of constraints 402 can comprise constraints on gate types 502 (e.g., the types of gates in the CQC 202). For instance, the constraints on gate types 502 can specify that the CQC 202 should only comprise Clifford gates (e.g., Controlled Not (CNOT) gates, Hadamard gates, Phase gates). Accordingly, in such instances, the method to convert the quantum circuit 118 into CQC 202 can be determined based on the set of constraints 402.

In some cases, the method to convert the quantum circuit 118 into CQC 202 can be determined based on the set of constraints 402 via a machine learning model. In various aspects, the machine learning model can be trained on a training dataset that comprises sets of constraints on a simulation search space with corresponding ground-truth annotations, wherein the ground-truth annotations can comprise a method to convert the quantum circuit 118 into CQC 202 that adheres to the corresponding sets of constraints. The machine learning model can undergo any suitable training method to determine the method to convert the quantum circuit 118 into CQC 202 (e.g., supervised training, unsupervised training, semi-supervised training).

As another non-limiting example, the set of constraints 402 can comprise constraints on the number of qubits 504 for simulation. For instance, the constraints on the number of qubits 504 can specify a maximum of 10 qubits for simulation. As yet another non-limiting example, the set of constraints 402 can comprise constraints on the number of gates 506 for simulation. For instance, constraints on the number of gates 506 can specify that the CQC 202 is to comprise a maximum of 40 gates for simulation. As still another non-limiting example, the set of constraints 402 can comprise constraints on boundaries of simulation parameters 508 (e.g., parameter boundaries 508) for the simulation. For instance, the parameter boundaries 508 can specify error rate bounds (e.g., limits error rates for gates to be between 0.001 and 0.01) or noise model parameters (e.g., limits depolarizing noise levels to a specified range).

It should be appreciated that while examples of defined constraints are provided herein, use of any constraints related to simulation of a quantum circuit and/or circuit performance is envisioned.

In various aspects, the set of starting points 404 can comprise initial parameters for simulation of the CQC 202 with the simplified noise model 204 and the validation and/or optimization workflow. As a non-limiting example, the set of starting points 404 can comprise initial conditions 510 for simulation of CQC 202. For instance, the initial conditions 510 can specify initial conditions of qubit states in the CQC 202 (e.g., specify that all qubits in the CQC 202 start in the |0 [symbol] state), or can specify initial noise levels (e.g., assuming a baseline depolarizing noise rate of 0.01 for all gates). As another non-limiting example, the set of starting points 404 can comprise initial parameters for configurations 512 of simulation of CQC 202. For instance, the configurations 512 can specify initial configurations of gate times, such as specifying that all single-qubit gates have a duration of 50 ns. As yet another non-limiting example, the set of starting points 404 can comprise any other suitable initial parameters 514 for simulation of CQC 202, such as initial calibration data (e.g., calibration data from previous experiments, including calibration curves for gate fidelities or coherence times).

It should be appreciated that while examples of defined starting points are provided herein, use of any starting points related to simulation of a quantum circuit and/or circuit performance is envisioned.

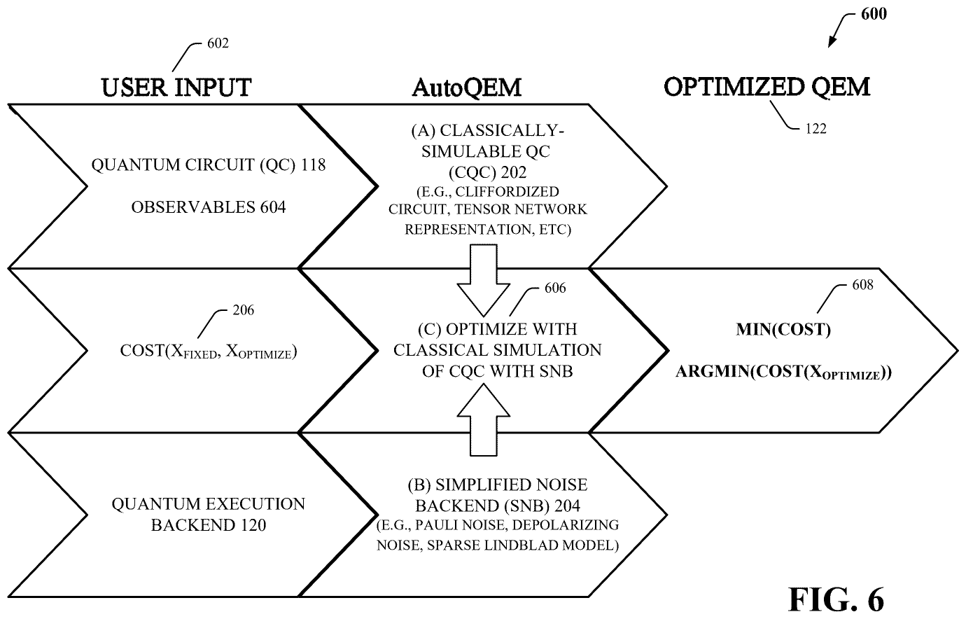

FIG. 6 illustrates an example, non-limiting diagram 600 of a workflow of scalable validation and optimization of quantum error mitigation computational workflows in accordance with one or more embodiments described herein.

As shown, in various aspects, the input component 110 can receive user input 602. The user input can comprise quantum circuit 118 and observables 604. The observables 604 are the measurable quantities in a quantum system, such expectation values of operators that correspond to measurable quantities of interest (e.g., energy levels, magnetization, specific qubit states) which are used to evaluate the performance and accuracy of the quantum computations. In other words, the observables 604 are used to evaluate the accuracy of the simulation by measuring their expectation values which inform the cost function for optimization of the QEM configuration.

In various aspects, the user input 602 can further comprise the cost function 206. As shown, the cost function can comprise the set of fixed variables 302, denoted by X_{fixed}, and the set of optimizable variables 304, denoted by X_{optimize}. Further, the user input 602 can comprise the quantum execution backend 120.

In various aspects, the workflow of scalable validation and optimization of quantum error mitigation computational workflows can comprise converting the quantum circuit 118 into CQC 202. For example, the CQC 202 can be, but is not limited to, a Cliffordized circuit or a tensor network representation.

In some embodiments, the workflow of scalable validation and optimization of quantum error mitigation computational workflows can also comprise learning the simplified noise model 204 of the quantum execution backend 120 (e.g., simplified noise backend (SND) 204). For example, the simplified noise model 204 can be, but is not limited to, a Pauli noise model, a depolarizing noise model, or a sparse Lindblad model.

In various aspects, in response to converting the quantum circuit 118 into CQC 202 and learning the simplified noise model 204 of the quantum execution backend 120, the evaluation component 116 can optimize the QEM configuration with classical simulation of the CQC 202 with the simplified noise model 204, as shown at 606. That is, simulation can be performed classically, without utilizing additional quantum resources in the QEM computational workflow. In other words, such embodiments can provide the advantage of optimizing the QEM configuration without additional quantum resources and corresponding costs of the quantum resources.

In various aspects, optimization of QEM configuration with classical simulation of the CQC 202 with the simplified noise model 204 can produce as output an evaluated cost function 608. In particular, if validation is performed, the evaluation component 116 can evaluate the minimum error rate achieved in simulation for the QEM configuration, denoted by min(Cost). That is, the evaluation component 116 can estimate the minimum value of the cost function 206 evaluated under the QEM configuration. In other cases, if optimization is performed over the set of fixed variables 302 and the set of optimizable variables 304, the evaluation component 116 can determine a set of optimized variables that achieve the minimum error rate, denoted by argmin(Cost(X_{optimize})). In other words, the evaluation component 116 can obtain the optimized QEM configuration 122, where the optimized QEM configuration 122 minimizes the cost function 206 over the set of fixed variables 302 and the set of optimizable variables 304. As an example, in cases when ZNE is applied, the optimized QEM configuration 122 can comprise noise factors and an extrapolation function (e.g., the optimized noise scaling factors and parameters of the extrapolation function for executing the quantum circuit 118 with ZNE). As another example, the minimized cost function can define a number of shots for a fixed (e.g., desired) level of precision. Alternatively, the minimized cost function can define the optimal level of precision for a fixed number of shots.

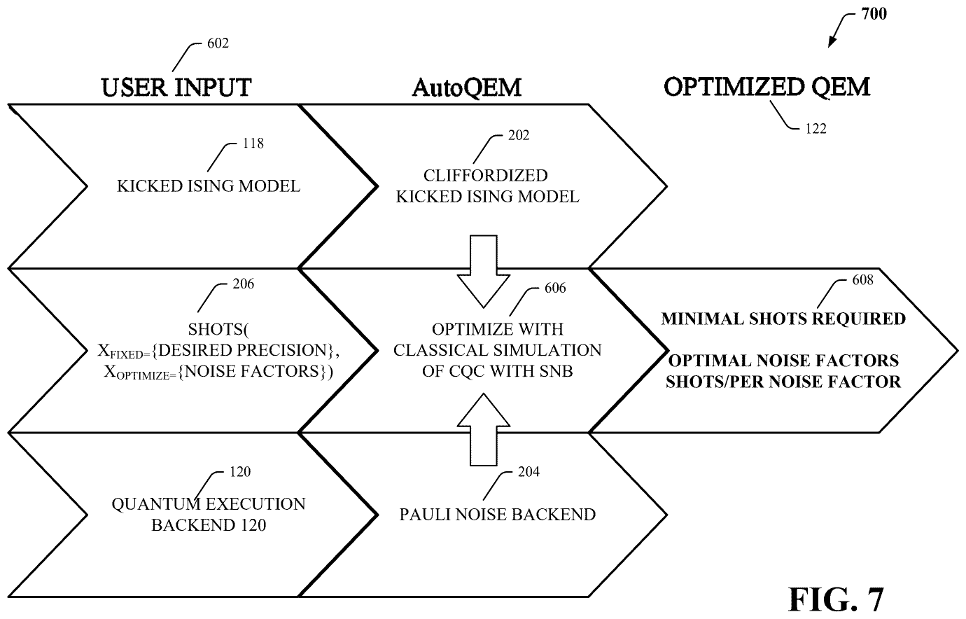

FIG. 7 illustrates an example, non-limiting diagram 700 of a workflow of scalable validation and optimization of quantum error mitigation computational workflows in accordance with one or more embodiments described herein.

Shown in FIG. 7 is an example implementation of the workflow of scalable validation and optimization of quantum error mitigation computational workflows. As a non-limiting example, it can be desired to optimize the QEM configuration for probabilistic error amplification over quantum circuit 118. For instance, the quantum circuit 118 can be a kicked Ising model (e.g., a variant of the Ising model in which the quantum system undergoes periodic, time-dependent perturbations or “kicks,” which introduce dynamic changes to the interactions between spins). In various embodiments, the quantum circuit conversion component 112 can convert the kicked Ising model into CQC 202. For example, the quantum circuit conversion component 112 can Cliffordize the kicked Ising model into a Cliffordized kicked Ising model. Furthermore, the quantum execution backend 120 can be a superconducting qubit-based quantum processor. In various aspects, the noise component 114 can learn the simplified noise model 204 of the superconducting qubit-based quantum processor. For example, the noise component 114 can learn a Pauli noise model of the superconducting qubit-based quantum processor. In response to converting the kicked Ising model into a Cliffordized kicked Ising model and learning the Pauli noise model of the superconducting qubit-based quantum processor, the evaluation component 116 can optimize the QEM configuration by classically simulating the Cliffordized kicked Ising model with the Pauli noise model. Accordingly, the evaluation component 116 can validate the QEM configuration and/or optimize the QEM configuration. Specifically, for example, the evaluation component 116 can determine the minimal shots required for execution of the kicked Ising model with the QEM configuration. Furthermore, for instance, the evaluation component 116 can obtain the optimized QEM configuration 122, which can comprise the optimal noise factors for a fixed number of shots, or can comprise the optimal number of shots for a fixed noise factor. In any case, the optimized QEM configuration 122 can be obtained with classical simulation, mitigating use of additional quantum resources for QEM computational workflows.

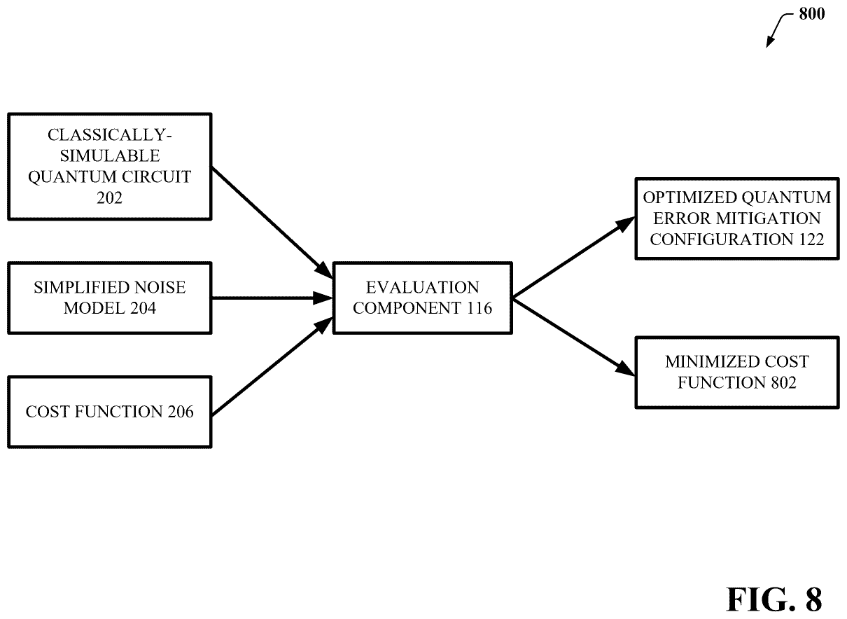

FIG. 8 illustrates a block diagram of an example, non-limiting system 800 that can facilitate scalable validation and optimization of quantum error mitigation computational workflows in accordance with one or more embodiments described herein.

In various embodiments, as previously described, FIG. 8 depicts the inputs and outputs of evaluation component 116 to facilitate validation and/or optimization of the QEM configuration for a desired QEM method. In various aspects, the inputs can comprise CQC 202, Simplified noise model 204, and cost function 206. In various cases, the inputs (e.g., CQC 202, Simplified noise model 204, and cost function 206) can be determined by an entity. That is, the entity can input any desired quantum circuit (e.g., quantum circuit 118) and any suitable quantum execution backend for which the desired quantum circuit will be executed on with a desired QEM method. In some cases, the inputs can further comprise the set of constraints 402 or the set of starting points 404. The set of constraints 402 or the set of starting points 404 can be determined based on input received by an entity. In some instances, the input can further comprise the set of fixed variables 302 and the set of optimizable variables 304. In other words, an entity can input or define which parameters or variables are to be fixed and which parameters or variables are to be optimized over. Such embodiments allow an entity to implement customizable configurations to optimize a QEM configuration, thereby providing comprehensive applicability of validation and optimization of QEM configurations for a broad range of QEM methods.

In any case, based on the inputs, the evaluation component 116 can output the optimized QEM configuration 122 and a minimized cost function 802. As previously described, the optimized QEM configuration 122 and the minimized cost function 802 generated will depend on the inputs customized by an entity. For example, based on the set of fixed variables 302 and the set of optimizable variables 304 determined by a user, the evaluation component 116 will output a different minimized cost function that corresponds to the selected set of fixed variables 302 and set of optimizable variables 304.

As a non-limiting example, an entity can specify in the set of fixed variables 302 that a desired maximum cost of computational resources is $1 million, and a desired level of accuracy is 50%. Further, the entity can specify for memory overhead to be in the set of optimizable variables 304. Accordingly, the evaluation component 116 can determine the optimal amount of memory (e.g., the minimum amount of memory) that is needed to achieve 5% accuracy with less than $1 million in computational resources costs. As another non-limiting example, an entity can specify in the set of fixed variables 302 that a desired level of accuracy is 80%, and can specify for the cost of computational resources to be in the set of optimizable variables 304. Accordingly, the evaluation component 116 can determine the minimum cost of computational resources that can facilitate the desired level of accuracy. Therefore, the cost function 206 can be flexible or customizable depending on user preferences or preferences determined by an entity.

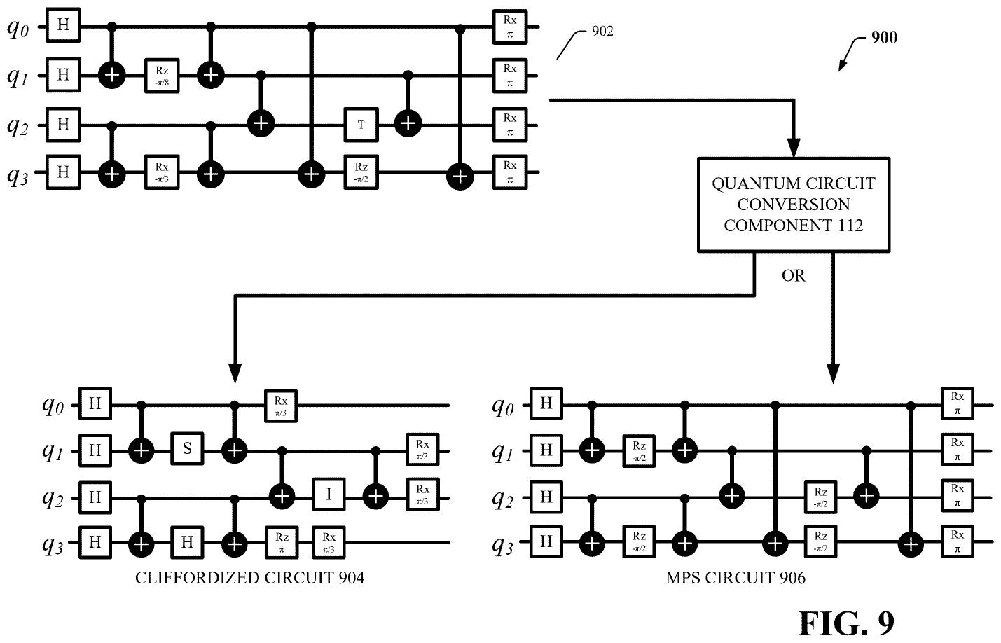

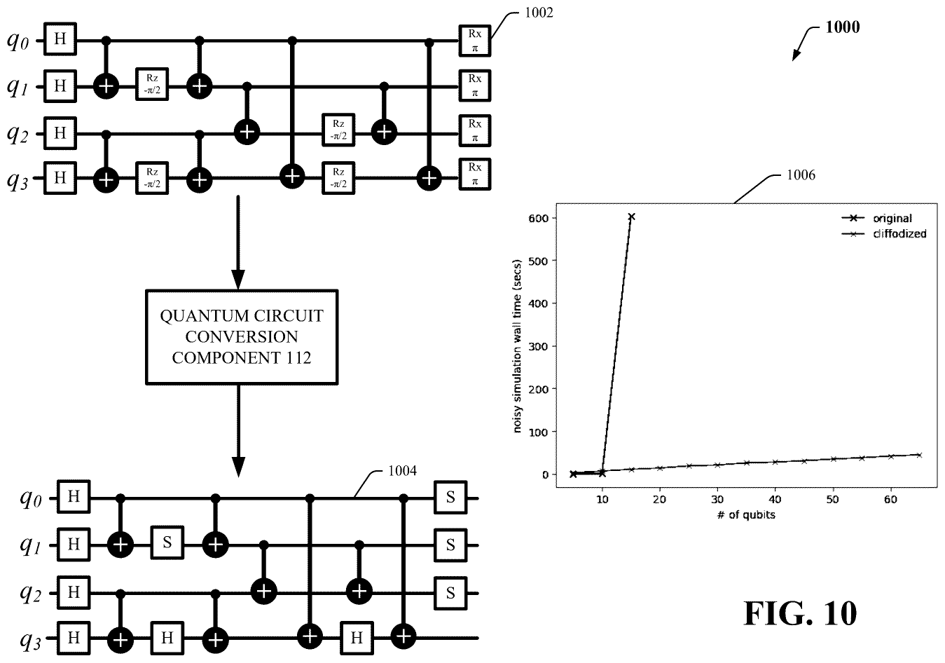

FIGS. 9-10 illustrate example, non-limiting diagrams 900 and 1000 of converting a quantum circuit into a classically simulable quantum circuit in accordance with one or more embodiments described herein.

Non-limiting diagrams 900 and 1000 illustrate example CQCs of an input quantum circuit. As shown in non-limiting diagram 900, the quantum circuit 118 can be represented by circuit 902. The circuit 902 can be input into quantum circuit conversion component 112 to generate a CQC of the circuit 902. For instance, the quantum circuit conversion component 112 can Cliffordize circuit 902 to generate a Cliffordized circuit 904 that is classically simulable (e.g., an accurate proxy circuit for evaluating QEM performance of quantum circuit 118). As another example, the quantum circuit conversion component 112 can convert the circuit 902 into a matrix product state (MPS) circuit 906, which is classically simulable.

As shown in non-limiting diagram 1000, the quantum circuit conversion component 112 can receive as input circuit 1002. Accordingly, the quantum circuit conversion component 112 can convert the circuit 1002 into a Cliffordized circuit 1004 that is a classically simulable proxy circuit for circuit 1002. Illustrated in graph 1006 are performance results from simulating the original quantum circuit 1002 received as input and from simulating the Cliffordized circuit 1004. As shown, Cliffordizing the circuit 1002 before classical simulation can improve scalability of validation and optimization of QEM computational workflows. Specifically, runtime can be significantly decreased from converting the circuit 1002 into a CQC. For example, the Cliffordized circuit 1004 exhibits a runtime of less than two minutes for up to 60 qubits. Conversely, the original circuit 1002 exhibits exponential runtimes for more than 10 qubits. Therefore, simulating the original circuit 1002 classically is not scalable to higher numbers of qubits. However, scalability can be enabled by converting the original circuit 1002 into a CQC.

FIG. 11 illustrates an example, non-limiting diagram 1100 of selecting a simplified noise model in accordance with one or more embodiments described herein.

In various aspects, the noise component 114 can select any suitable noise learning model to approximate the noise on the quantum execution backend 120. For instance, there can be a range 1102 of noise learning methods that can be implemented, depending on a desired level of accuracy or computational overhead. For example, the range 1102 of noise learning models can consist of noise learning models that exhibit high accuracy at the cost of quantum processing unit (QPU) overhead. As another example, the range 1102 of noise learning models can also consist of noise learning models that exhibit low accuracy with decreased QPU overhead. Accordingly, the noise component 114 can select the simplified noise model 204 to approximate noise of the quantum execution backend 120 based on the set of fixed variables 302, the set of optimizable variables 304, the set of constraints 402, or the set of starting points 404. For example, if an entity specifies in the set of fixed variables 302 that a high, specified level of accuracy is desired, noise component 114 can select a simplified noise model that can provide such desired level of accuracy. As a non-limiting example, a simplified noise model that provides high accuracy with high QPU overhead is a PEC noise learning model 1104. As another non-limiting example, a simplified noise model that provides a moderate level of accuracy with moderate QPU overhead is an error per layer gate (EPLG) model 1106. As yet another non-limiting example, a simplified noise model that provides low accuracy with low QPU overhead is stored calibration data 1108. As such, the noise component 114 can select low accuracy and low QPU overhead simplified noise models to facilitate validation and optimization of the QEM configuration with little to no quantum resources.

FIG. 12 illustrates an example, non-limiting diagram 1200 of optimization inputs and an optimization search space in accordance with one or more embodiments described herein.

In various aspects, FIG. 12 depicts example optimizer inputs and a QEM configuration space 1202 for validating and optimizing the QEM configuration. As previously described, the optimizer input can comprise the CQC 202 and the simplified noise model 204. The optimizer inputs can further comprise the cost function 206. As a non-limiting example, the cost function 206 can be defined by Cost=f(accuracy)−g(QPU runtime), where the cost function 206 is being optimized over QPU runtime to achieve a desired level of accuracy. In various embodiments, validating the QEM configuration can comprise estimating an error at the QEM configuration in the QEM configuration space 1202. In various aspects, optimizing the QEM configuration can comprise searching the QEM configuration space 1202 to obtain the minimized error (e.g., minimize cost function) and the corresponding optimized QEM configuration that provides the minimized error. For example, as shown in QEM configuration space 1202, the minimum error can be provided by the optimized QEM configuration comprising a particular noise factor and extrapolation order.

FIG. 13 illustrates an example, non-limiting diagram 1300 of memory overhead and efficiency of evaluating cost functions in accordance with one or more embodiments described herein.

Illustrated by FIG. 13 is a graph 1302 that depicts memory utilization for simulating the CQC 202. As shown, simulating the CQC 202 (e.g., an MPS representation of quantum circuit 118) is memory efficient. In particular, as a problem size increases, the memory usage plateaus as the number of qubits increases. Conversely, if the quantum circuit 118 is simulated instead of the CQC 202 that emulates how noise propagates in quantum circuit 118, the memory usage exponentially increases as the number of qubits increases, limiting implementation of more than approximately 20-30 qubits due to practical limitations of memory usage.

FIG. 14 illustrates an example, non-limiting diagram 1400 of simulation results of a quantum circuit in accordance with one or more embodiments described herein.

Illustrated in FIG. 14 is an example input quantum circuit 1402. As shown in graph 1404, simulating the input quantum circuit 1402 with PEA for error mitigation exhibits increased noise and error from the expectation values (e.g., the ideal values). Furthermore, as depicted in graph 1404, simulating the input quantum circuit 1402 exhibits increased spread of the errors. Conversely, as shown in graph 1406, and after implementing the various embodiments described herein, decreased error from the expectation values can be exhibited. Further, various embodiments described herein can result in lower spread of the errors. Moreover, such decrease in error can be achieved at no additional cost of quantum resources.

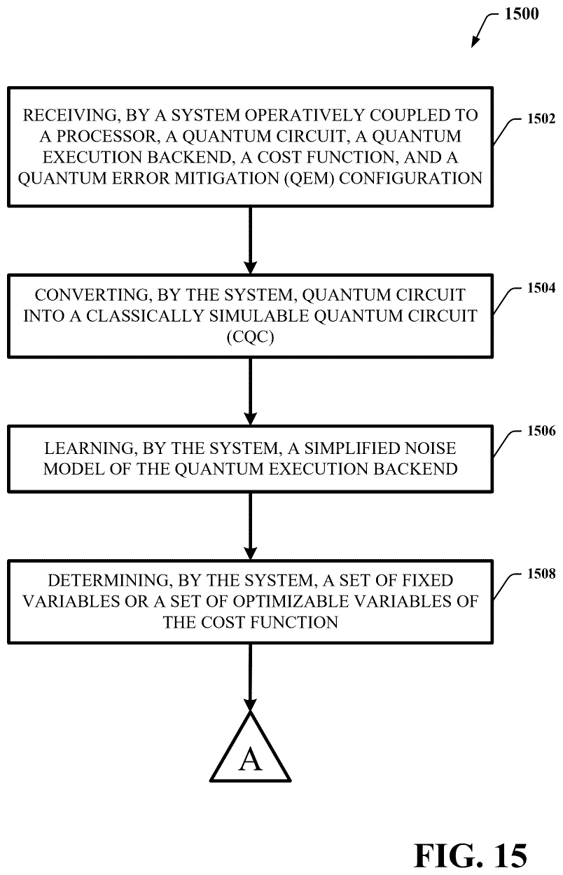

FIG. 15 illustrates a flow diagram of an example, non-limiting, computer implemented method 1500 that facilitates scalable validation and optimization of QEM computational workflows in accordance with one or more embodiments described herein. Repetitive description of like elements employed in other embodiments described herein is omitted for sake of brevity.

At 1502, method 1500 can comprise receiving, by a system (e.g., quantum error mitigation optimization system 102 and/or input component 110), a quantum circuit (e.g., 118), a quantum execution backend (e.g., 120), a cost function (e.g., 206), and a quantum error mitigation (QEM) configuration.

At 1504, method 1500 can comprise converting, by the system (e.g., quantum circuit conversion component 112), quantum circuit into a classically simulable quantum circuit (CQC) (e.g., 202).

At 1506, method 1500 can comprise learning (e.g., noise component 114), by the system, a simplified noise model (e.g., 204) of the quantum execution backend.

At 1508, method 1500 can comprise determining (e.g., evaluation component 116), by the system, a set of fixed variables (e.g., 302) or a set of optimizable variables (e.g., 304) of the cost function. In various aspects, the set of fixed variables or the set of optimizable variables can be determined and received by an entity via input component 110. That is, the set of fixed variables or the set of optimizable variables can be considered as customizable depending on preferences of the entity, thereby providing user-friendly integration of comprehensive and optimizable QEM into QEM computational workflows.

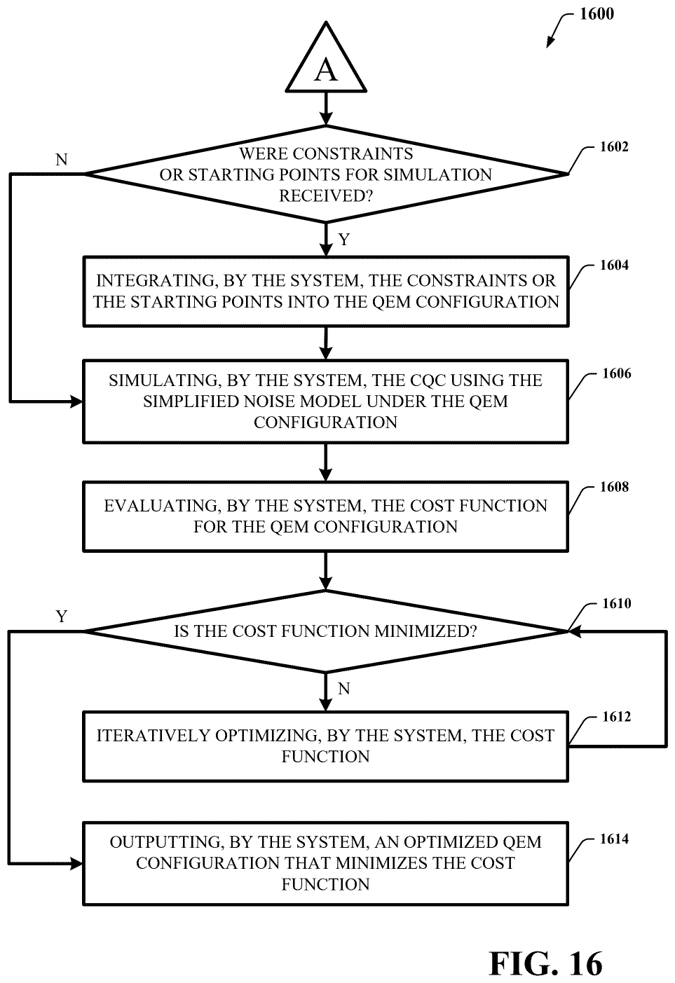

FIG. 16 illustrates a flow diagram of an example, non-limiting, computer implemented method 1600 that facilitates scalable validation and optimization of QEM computational workflows in accordance with one or more embodiments described herein.

With continued reference to non-limiting method 1500, non-limiting method 11600 can facilitate predictive profiling of quantum environments in accordance with one or more embodiments described herein. Repetitive description of like elements employed in other embodiments described herein is omitted for sake of brevity.

At 1602, non-limiting method 1600 can include determining, by the system (e.g., input component 110), if constraints (e.g., 402) or starting points (e.g., 404) for simulation were received. If yes (e.g., constraints or starting points for simulation were received), the non-limiting method 1600 can proceed to 1604. If no (e.g., constraints or starting points for simulation were not received), the non-limiting method 1600 can proceed to 1606.

At 1604, non-limiting method 1600 can comprise integrating, by the system (e.g., evaluation component 116), the constraints or the starting points into the QEM configuration. In one or more embodiments, the constraints or the starting points can be considered as customizable. That is, any constraints or starting points received by an entity can be integrated into the QEM configuration for simulation of the quantum circuit, enabling user-friendly integration of optimizable QEM into QEM computational workflows.

At 1606, non-limiting method 1600 can comprise simulating, by the system (e.g., evaluation component 116), the CQC using the simplified noise model under the QEM configuration.

At 1608, non-limiting method 1600 can evaluating, by the system (e.g., evaluation component 116), the cost function for the QEM configuration. In one or more embodiments, the amount of memory and time to evaluate the cost function is decreased as the quantum circuit is classically simulated, thereby providing a practical improvement in performance of systems executing quantum circuits with QEM in quantum computing.

At 1610, non-limiting method 1600 can include determining, by the system (e.g., evaluation component 116), if the cost function is minimized. If yes (e.g., the cost function is minimized), the non-limiting method 1600 can proceed to 1614. If no (e.g., the cost function is not minimized), the non-limiting method 1600 can proceed to 1612.

At 1612, non-limiting method 1600 can comprise iteratively optimizing, by the system (e.g., evaluation component 116), the cost function. In various aspects, iterative optimization can comprise executing an iterative loop that determines the optimized QEM configuration 122 that minimizes error in the expectation values (e.g., the minimized cost function 206). Specifically, a feedback loop can be executed where data from previous simulations are utilized to adjust or refine the QEM configuration. In various instances, the evaluation component 116 can employ any suitable optimization techniques. For example, gradient-based optimizers (e.g., gradient descent, stochastic gradient descent), convex optimizers (e.g., quadratic programming), variational optimizers (e.g., Variational Autoencoders), or Bayesian optimizers (e.g., Bayesian optimization with expected improvement, Gaussian processes) can be employed.

At 1614, non-limiting method 1600 can comprise outputting, by the system (e.g., evaluation component 116), an optimized QEM configuration (e.g., 122) that minimizes the cost function. In one or more embodiments, the optimized QEM configuration and minimized cost function can be obtained by only classical computation, mitigating the need for additional quantum resources for validating and optimizing QEM computational workflows, thereby providing a practical improvement in performance of systems executing quantum circuits with QEM.

Quantum error mitigation optimization system 102 can provide technical improvements to a processing unit associated with quantum error mitigation optimization system 102. For example, by a utilizing simplified noise model and CQCs, circuit simulation can exhibit increased processing efficiency, thereby reducing the workload of a processing unit (e.g., processor 104). In this example, by reducing the workload of such a processing unit (e.g., processor 104), quantum error mitigation optimization system 102 can thereby facilitate improved performance, improved efficiency, and/or reduced computational cost associated with such a processing unit. Further, by utilizing a CQC (e.g., CQC 202) and a simplified noise model (e.g., simplified noise model 204), instead of the original quantum circuit (e.g., quantum circuit 118), the amount of quantum resources utilized by quantum error mitigation optimization system 102 is reduced, thereby reducing or removing the additional workload of a QPU of a quantum system associated with executing the quantum circuit with QEM. Quantum error mitigation optimization system 102 can thereby facilitate improved performance, improved efficiency, and/or reduced computational cost associated with quantum computation on a quantum processor.

A practical application of quantum error mitigation optimization system 102 is that it allows for implementing quantum error mitigation methods by utilizing a reduced amount of quantum computing resources, in comparison to other methods. For example, quantum circuits can be unscalable for classical simulation and costly to implement quantum hardware, which limits the capability of performing scalable validation and optimization of quantum error mitigation computational workflows. Furthermore, as the number of qubits increases, the storage requirements of quantum simulation for QEM computational workflows increases while processing efficiency decreases. By eliminating the requirement for quantum resources to simulate quantum circuits for QEM workflows, quantum error mitigation optimization system 102 can enable scalable validation and optimization of quantum error mitigation computational workflows with greater numbers of qubits, decreased storage requirements, and improved processing efficiency. Quantum error mitigation optimization system 102 can additionally provide comprehensive methods for validation and optimization of quantum error mitigation computational workflows that can be applied to any QEM method in comparison to various other approaches. Therefore, quantum error mitigation optimization system 102 can enable scalable validation and optimization of quantum error mitigation computational workflows that can be operated with reduced quantum hardware requirements, thus promoting scalability of quantum systems.

It is to be appreciated that quantum error mitigation optimization system 102 can utilize various combination of electrical components, mechanical components, and circuitry that cannot be replicated in the mind of a human or performed by a human as the various operations that can be executed by quantum error mitigation optimization system 102 and/or components thereof as described herein are operations that are greater than the capability of a human mind. For instance, the amount of data processed, the speed of processing such data, or the types of data processed by quantum error mitigation optimization system 102 over a certain period of time can be greater, faster, or different than the amount, speed, or data type that can be processed by a human mind over the same period of time. According to several embodiments, quantum error mitigation optimization system 102 can also be fully operational towards performing one or more other functions (e.g., fully powered on, fully executed, and/or another function) while also performing the various operations described herein. It should be appreciated that such simultaneous multi-operational execution is beyond the capability of a human mind. It should be appreciated that quantum error mitigation optimization system 102 can include information that is impossible to obtain manually by an entity, such as a human user. For example, the type, amount, and/or variety of information included in quantum error mitigation optimization system 102 can be more complex than information obtained manually by an entity, such as a human user.

FIG. 17 illustrates a block diagram of an example, non-limiting operating environment 1700 in which one or more embodiments described herein can be facilitated. FIG. 17 and the following discussion are intended to provide a general description of a suitable operating environment 1700 in which one or more embodiments described herein at FIGS. 1-16 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1700 contains an example of an environment for the execution of at least some of the computer code involved in performing the inventive methods, such as quantum error mitigation validation and optimization code 1745. In addition to block 1745, computing environment 1700 includes, for example, computer 1701, wide area network (WAN) 1702, end user device (EUD) 1703, remote server 1704, public cloud 1705, and private cloud 1706. In this embodiment, computer 1701 includes processor set 1710 (including processing circuitry 1720 and cache 1721), communication fabric 1711, volatile memory 1712, persistent storage 1713 (including operating system 1722 and block 1745, as identified above), peripheral device set 1714 (including user interface (UI), device set 1725, storage 1724, and Internet of Things (IoT) sensor set 1725), and network module 1715. Remote server 1704 includes remote database 1730. Public cloud 1705 includes gateway 1740, cloud orchestration module 1741, host physical machine set 1742, virtual machine set 1743, and container set 1744.

COMPUTER 1701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1730. As is well understood in the art of computer technology, and depending upon the technology, performance of a computer-implemented method may be distributed among multiple computers and/or between multiple locations. On the other hand, in this presentation of computing environment 1700, detailed discussion is focused on a single computer, specifically computer 1701, to keep the presentation as simple as possible. Computer 1701 may be located in a cloud, even though it is not shown in a cloud in FIG. 17. On the other hand, computer 1701 is not required to be in a cloud except to any extent as may be affirmatively indicated.

PROCESSOR SET 1710 includes one, or more, computer processors of any type now known or to be developed in the future. Processing circuitry 1720 may be distributed over multiple packages, for example, multiple, coordinated integrated circuit chips. Processing circuitry 1720 may implement multiple processor threads and/or multiple processor cores. Cache 1721 is memory that is located in the processor chip package(s) and is typically used for data or code that should be available for rapid access by the threads or cores running on processor set 1710. Cache memories are typically organized into multiple levels depending upon relative proximity to the processing circuitry. Alternatively, some, or all, of the cache for the processor set may be located “off chip.” In some computing environments, processor set 1710 may be designed for working with qubits and performing quantum computing.

Computer readable program instructions are typically loaded onto computer 1701 to cause a series of operational steps to be performed by processor set 1710 of computer 1701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1721 and the other storage media discussed below. The program instructions, and associated data, are accessed by processor set 1710 to control and direct performance of the inventive methods. In computing environment 1700, at least some of the instructions for performing the inventive methods may be stored in block 1745 in persistent storage 1713.

COMMUNICATION FABRIC 1711 is the signal conduction paths that allow the various components of computer 1701 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1712 is any type of volatile memory now known or to be developed in the future. Examples include dynamic type random access memory (RAM) or static type RAM. Typically, the volatile memory is characterized by random access, but this is not required unless affirmatively indicated. In computer 1701, the volatile memory 1712 is located in a single package and is internal to computer 1701, but, alternatively or additionally, the volatile memory may be distributed over multiple packages and/or located externally with respect to computer 1701.

PERSISTENT STORAGE 1713 is any form of non-volatile storage for computers that is now known or to be developed in the future. The non-volatility of this storage means that the stored data is maintained regardless of whether power is being supplied to computer 1701 and/or directly to persistent storage 1713. Persistent storage 1713 may be a read only memory (ROM), but typically at least a portion of the persistent storage allows writing of data, deletion of data and re-writing of data. Some familiar forms of persistent storage include magnetic disks and solid state storage devices. Operating system 1722 may take several forms, such as various known proprietary operating systems or open source Portable Operating System Interface type operating systems that employ a kernel. The code included in block 1745 typically includes at least some of the computer code involved in performing the inventive methods.

PERIPHERAL DEVICE SET 1714 includes the set of peripheral devices of computer 1701. Data communication connections between the peripheral devices and the other components of computer 1701 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1725 may include components such as a display screen, speaker, microphone, wearable devices (such as goggles and smart watches), keyboard, mouse, printer, touchpad, game controllers, and haptic devices. Storage 1724 is external storage, such as an external hard drive, or insertable storage, such as an SD card. Storage 1724 may be persistent and/or volatile. In some embodiments, storage 1724 may take the form of a quantum computing storage device for storing data in the form of qubits. In embodiments where computer 1701 is required to have a large amount of storage (for example, where computer 1701 locally stores and manages a large database) then this storage may be provided by peripheral storage devices designed for storing very large amounts of data, such as a storage area network (SAN) that is shared by multiple, geographically distributed computers. IoT sensor set 1725 is made up of sensors that can be used in Internet of Things applications. For example, one sensor may be a thermometer and another sensor may be a motion detector.

NETWORK MODULE 1715 is the collection of computer software, hardware, and firmware that allows computer 1701 to communicate with other computers through WAN 1702. Network module 1715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1715 are performed on the same physical hardware device. In other embodiments (for example, embodiments that utilize software-defined networking (SDN)), the control functions and the forwarding functions of network module 1715 are performed on physically separate devices, such that the control functions manage several different network hardware devices. Computer readable program instructions for performing the inventive methods can typically be downloaded to computer 1701 from an external computer or external storage device through a network adapter card or network interface included in network module 1715.

WAN 1702 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1703 is any computer system that is used and controlled by an end user (for example, a customer of an enterprise that operates computer 1701), and may take any of the forms discussed above in connection with computer 1701. EUD 1703 typically receives helpful and useful data from the operations of computer 1701. For example, in a hypothetical case where computer 1701 is designed to provide a recommendation to an end user, this recommendation would typically be communicated from network module 1715 of computer 1701 through WAN 1702 to EUD 1703. In this way, EUD 1703 can display, or otherwise present, the recommendation to an end user. In some embodiments, EUD 1703 may be a client device, such as thin client, heavy client, mainframe computer, desktop computer and so on.

REMOTE SERVER 1704 is any computer system that serves at least some data and/or functionality to computer 1701. Remote server 1704 may be controlled and used by the same entity that operates computer 1701. Remote server 1704 represents the machine(s) that collect and store helpful and useful data for use by other computers, such as computer 1701. For example, in a hypothetical case where computer 1701 is designed and programmed to provide a recommendation based on historical data, then this historical data may be provided to computer 1701 from remote database 1730 of remote server 1704.

PUBLIC CLOUD 1705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 1705 is performed by the computer hardware and/or software of cloud orchestration module 1741. The computing resources provided by public cloud 1705 are typically implemented by virtual computing environments that run on various computers making up the computers of host physical machine set 1742, which is the universe of physical computers in and/or available to public cloud 1705. The virtual computing environments (VCEs) typically take the form of virtual machines from virtual machine set 1743 and/or containers from container set 1744. It is understood that these VCEs may be stored as images and may be transferred among and between the various physical machine hosts, either as images or after instantiation of the VCE. Cloud orchestration module 1741 manages the transfer and storage of images, deploys new instantiations of VCEs and manages active instantiations of VCE deployments. Gateway 1740 is the collection of computer software, hardware, and firmware that allows public cloud 1705 to communicate through WAN 1702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1706 is similar to public cloud 1705, except that the computing resources are only available for use by a single enterprise. While private cloud 1706 is depicted as being in communication with WAN 1702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1705 and private cloud 1706 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
an input component that receives a quantum error mitigation (QEM) configuration of a quantum circuit and a quantum execution backend;
a quantum circuit conversion component that converts the quantum circuit into a classically simulable quantum circuit; and
a noise component that learns a simplified noise model of the quantum execution backend; and
an evaluation component that validates or optimizes the QEM configuration over the classically simulable quantum circuit and the simplified noise model.

2. The system of claim 1, wherein the input component receives a cost function, wherein the cost function comprises a set of fixed variables and a set of optimizable variables.

3. The system of claim 2, wherein validating the QEM configuration comprises:
estimating the cost function at the QEM configuration.

4. The system of claim 2, wherein optimizing the QEM configuration comprises:
minimizing the cost function to obtain an optimized QEM configuration over the fixed variables and the optimizable variables.

5. The system of claim 1, wherein validating or optimizing the QEM configuration comprises:
simulating the classically simulable quantum circuit using the simplified noise model over the QEM configuration.

6. The system of claim 5, wherein the input component receives starting points for simulation of the classically simulable quantum circuit.

7. The system of claim 6, wherein the starting points comprise at least one of: initial conditions, configurations, or parameters for the simulation.

8. The system of claim 5 wherein the input component receives constraints on a search space for simulation of the classically simulable quantum circuit.

9. The system of claim 8, wherein the constraints on the search space comprise constraints on at least one of: types of gates, number of qubits simulated, number of gates simulated, or boundaries of simulation parameters for the simulation.

10. The system of claim 2, wherein the set of fixed variables and a set of optimizable variables in the cost function quantifies a total number of executions, a level of precision of QEM results, noise factors, or runtime.

11. The system of claim 2, wherein the evaluation component evaluates the cost function using stabilizer simulation backends.

12. The system of claim 1, wherein converting the quantum circuit into a classically simulable quantum circuit comprises:
converting the quantum circuit into a classically simulable proxy circuit.

13. A computer-implemented method, comprising:
receiving, by a system operatively coupled to a processor, a quantum error mitigation (QEM) configuration of a quantum circuit and a quantum execution backend;
converting, by the system, the quantum circuit into a classically simulable quantum circuit;
learns, by the system, a simplified noise model of the quantum execution backend; and
validating or optimizing, by the system, the QEM configuration over the classically simulable quantum circuit and the simplified noise model.

14. The computer-implemented method of claim 11, further comprising:
receiving, by the system, a cost function, wherein the cost function comprises a set of fixed variables and a set of optimizable variables.

15. The computer-implemented method of claim 14, wherein validating the QEM configuration comprises:
estimating the cost function at the QEM configuration.

16. The computer-implemented method of claim 14, wherein optimizing the QEM configuration comprises:
minimizing the cost function to obtain an optimized QEM configuration over the fixed variables and the optimizable variables.

17. The system of claim 1, wherein validating or optimizing the QEM configuration comprises:
simulating the classically simulable quantum circuit using the simplified noise model over the QEM configuration.

18. The computer-implemented method of claim 13, further comprising:
receiving, by the system, starting points or constraints on a search space for simulation of the classically simulable quantum circuit.

19. A computer program product for scalable validation and optimization of quantum error mitigation computational workflows, the computer program product comprising a computer readable storage medium having program instructions embodied therewith, the program instructions executable by a processor to cause the processor to:
receive, by the processor, a quantum error mitigation (QEM) configuration of a quantum circuit and a quantum execution backend;
convert, by the processor, the quantum circuit into a classically simulable quantum circuit;
learn, by the processor, a simplified noise model of the quantum execution backend; and
validate or optimize, by the processor, the QEM configuration over the classically simulable quantum circuit and the simplified noise model.

20. The computer program product of claim 19, wherein the program instructions are further executable by the processor to cause the processor to:
receive, by the processor, a cost function, wherein the cost function comprises a set of fixed variables and a set of optimizable variables; and
minimize the cost function to obtain an optimized QEM configuration over the fixed variables and the optimizable variables.
